(19) United States
(12) Patent Application Publication
(10) Pub. No.: US 2025/0306179 A1
(43) Pub. Date: Oct. 2, 2025

(54) Optical Element Drive Device And Ranging System

(71) Applicant: Alps Alpine Co., Ltd., Tokyo (JP)

(72) Inventors: Jun ANDO, Tokyo (JP); Masahito NAMAI, Miyagi-ken (JP); Takuya KATO, Miyagi-ken (JP); Ryotaro ANZO, Tokyo (JP)

(21) Appl. No.: 19/234,498

(22) Filed: Jun. 11, 2025

Related U.S. Application Data
(63) Continuation of application No. PCT/JP2023/044859, filed on Dec. 14, 2023.

(30) Foreign Application Priority Data
Dec. 19, 2022 (JP) 2022-201842

(51) Int. Cl. G01S 7/481; G01S 17/08

(52) U.S. Cl. CPC G01S 7/4817; G01S 17/08

(57) ABSTRACT

An optical element drive device for a ranging system that can be disposed adjacent to a light receiving device includes a drive unit including a magnetic field generation member and a coil. A fixing member includes an outer portion that is disposed adjacent to the light receiving device. The drive unit is disposed at a position further away from the outer portion than a portion, of the penetration, where the optical element is disposed. A first coil includes a first extension and a second extension extending along a first extension direction, and a second coil includes a third extension and a fourth extension extending along a second extension direction. The first extension direction and the second extension direction are substantially orthogonal to each other in plan view along the vertical direction.

### CLAIM OF PRIORITY

This application is a Continuation of International Application No. PCT/JP2023/044859 filed on Dec. 14, 2023, which claims benefit of Japanese Patent Application No. 2022-201842 filed on Dec. 19, 2022. The entire contents of each application noted above are hereby incorporated by reference.

### BACKGROUND OF THE INVENTION

### 1. Field of the Invention

The present disclosure relates to an optical element drive devices and a ranging system.

### 2. Description of the Related Art

In the related art, a ranging system is known that measures the distance to a subject by irradiating a plurality of ranging points on the subject with light from a plurality of light emitting elements in a light emitting device (see International Publication No. 2022/085381). This ranging system is configured so that a light receiving device and a light emitting device are disposed adjacent to each other in the Y axis direction in the XY plane perpendicular to a direction toward the subject (Z axis direction), and an optical system (optical elements) including a collimate lens and diffractive optical elements that can be moved in the X axis direction in order to increase the number of ranging points. In other words, in the ranging system, while movement of the optical element in the X axis direction by disposing a pair of moving units (coil and permanent magnet) with the optical element in the X axis direction interposed therebetween is implemented, the distance (base line length) between the center axis of the light receiving device the center axis of the light emitting device is shortened by not disposing a moving unit between the light receiving device and the light emitting device in the Y axis direction.

However, this ranging system is not able to move the optical element in the Y axis direction. As described above, this is because the ranging system employs single-axis driving that enables movement of the optical element in the X axis direction only, instead of two-axis driving that enables movement of the optical element in the X axis direction and the Y axis direction, in order to avoid an increase in the distance between the light emitting device (optical element) and the light receiving device.

Therefore, it is desirable to provide an optical element drive device for a ranging system with a configuration that can suppress the increase in the distance between the optical element and the light receiving device in the light emitting device, while employing the two-axis driving.

### SUMMARY OF THE INVENTION

An optical element drive device according to an embodiment of the present disclosure includes a fixing member including a base member, an optical element holding member having a penetration in which an optical element is allowed to be disposed, the penetration penetrating in a vertical direction, and facing the base member in the vertical direction, a support member configured to movably support the optical element holding member in a direction perpendicular to the vertical direction with respect to the base member, and a drive unit including at least a magnetic field generation member and a coil, the magnetic field generation member and the coil being configured to move the optical element holding member in the direction perpendicular to the vertical direction, wherein the fixing member has an outer portion that is disposed adjacent to a light receiving device constituting a ranging system in plan view along the vertical direction, wherein the drive unit is disposed at a position further away from the outer portion than a portion of the penetration, the portion where the optical element is disposed, wherein the magnetic field generation member includes a first magnetic field generation member and a second magnetic field generation member provided on one member of a movable member including the optical element holding member and the fixing member, wherein the coil includes a first coil and a second coil provided on the other member of the movable member and the fixing member, wherein the first coil faces the first magnetic field generation member in the vertical direction, wherein the second coil faces the second magnetic field generation member in the vertical direction, wherein the first coil has a first coil axis extending in the vertical direction, and has a first extension and a second extension provided facing each other with the first coil axis interposed therebetween and extending along a first extension direction, wherein the second coil has a second coil axis extending in the vertical direction, and has a third extension and a fourth extension provided facing each other with the second coil axis interposed therebetween and extending along a second extension direction, and wherein the first extension direction and the second extension direction are substantially orthogonal to each other in plan view along the vertical direction.

The optical element drive device described above can suppress the increase in the distance between the optical element disposed on the optical element holding member and the light receiving device while employing two-axis driving.

### BRIEF DESCRIPTION OF THE DRAWINGS

FIG. 1 is a perspective view of the ranging system;

FIG. 2 is a cross-sectional view of the ranging system;

FIG. 3 is a perspective view of the light emitting device;

FIG. 4 is an exploded perspective view of the lower member;

FIG. 5 is a bottom view of the optical element holding member;

FIG. 6 is a top view of the base member;

FIG. 7 is an exploded perspective view of the fixing member;

FIG. 8 is a three-view of the magnetic system;

FIG. 9 is a perspective view of the optical element holding member and the beam member;

FIG. 10 is a side view of the optical element holding member and the beam member;

FIG. 11 is a top view of the light emitting device;

FIG. 12 is a front view of the light emitting device;

FIG. 13 is a perspective view of another configuration example of the light emitting device; and

FIG. 14 is an exploded perspective view of the lower member constituting the light emitting device of FIG. 13.

### DESCRIPTION OF THE PREFERRED EMBODIMENTS

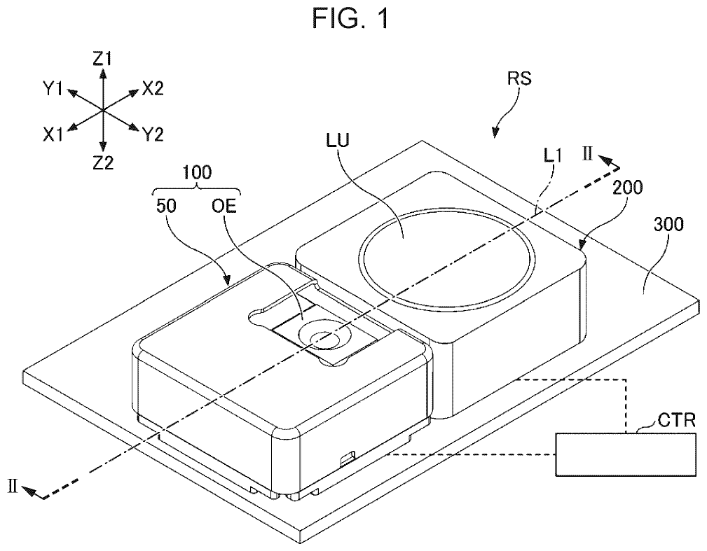

In the following, a ranging system RS according to the embodiment of the present disclosure is described with reference to the drawings. FIG. 1 is a perspective view of the ranging system RS including a light emitting device 100, a light receiving device 200, a substrate 300, and a control device CTR.

In FIG. 1, X1 represents one direction of the X axis that constitutes a three-dimensional Cartesian coordinate system, and X2 represents the other direction of the X axis. Y1 represents one direction of the Y axis that constitutes the three-dimensional Cartesian coordinate system, and Y2 represents the other direction of the Y axis. Similarly, Z1 represents one direction of the Z axis that constitutes the three-dimensional Cartesian coordinate system, and Z2 represents the other direction of the Z axis. In FIG. 1, the X1 side relative to the ranging system RS corresponds to in front (front side) of the ranging system RS, and the X2 side relative to the ranging system RS corresponds to rear (back side) of the ranging system RS. The Y1 side of the ranging system RS corresponds to the left side of the ranging system RS, and the Y2 side of the ranging system RS corresponds to the right side of the ranging system RS. The Z1 side of the ranging system RS corresponds to the upper side of the ranging system RS, and the Z2 side of the ranging system RS corresponds to the lower side of the ranging system RS. The same applies to the other figures.

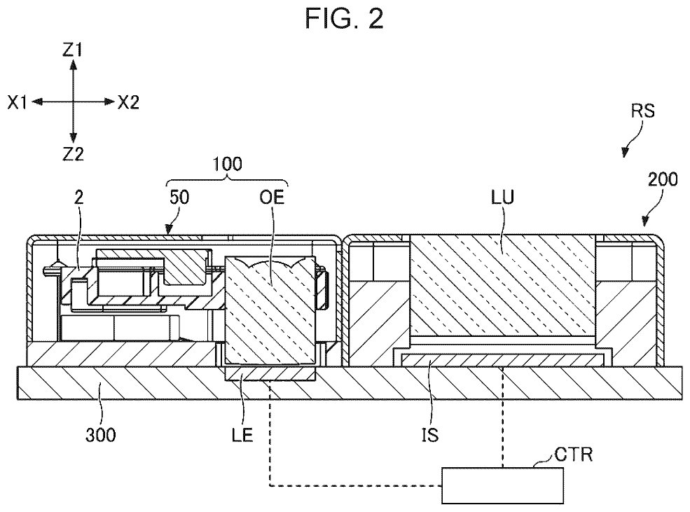

FIG. 2 shows a cross-sectional view of the ranging system RS in a virtual plane parallel to the XZ plane including an alternate long and short dashed line L1 in FIG. 1.

In the illustrated example, the ranging system RS is configured so that the light emitting device 100 emits light toward an object to be irradiated and the light receiving device 200 receives the light reflected from the irradiated object, so that the distance between the ranging system RS and each of a plurality of irradiation points on the irradiated object can be calculated based on the time of flight (ToF) of the light between the light emission time and the light reception time. In the following, a function of calculating the distance between the ranging system RS and each of the plurality of irradiation points on the irradiated object, the function being achieved by the ranging system RS, is also referred to as a ranging function.

Specifically, the light emitting device 100 includes a light emitting element LE, an optical element OE, and an optical element drive device 50. The light emitting element LE is, for example, an element having a larger number of emitters disposed in a two-dimensional array on the substrate 300. In the illustrated example, the light emitting element LE has a vertical cavity surface emitting laser (VCSEL) structure and is configured to generate laser light. The light generated by the light emitting element LE is, for example, visible light or infrared light. The optical element OE is an element that is movably supported in any direction on a virtual plane parallel to the XY plane. In the illustrated example, the optical element OE is a combination of a lens body and a diffractive optical element. The lens body is, for example, a collimate lens. The optical element OE may be a lens body or a diffractive optical element.

The light receiving device 200 includes a lens unit LU and an image sensor IS. In the illustrated example, the lens unit LU includes a plurality of lenses, and the light reflected by the object to be irradiated is focused by these lenses. Each of these lenses may be covered with an anti-reflective film to prevent light reflection. This anti-reflective film may function as a band pass filter (BPF) that transmits light of a wavelength same as that emitted from the light emitting device 100. Specifically, the image sensor IS is, for example, a CCD image sensor or a CMOS image sensor.

The control device CTR is a device that controls various operations of the ranging system RS. In the illustrated example, the control device CTR is a microcomputer including a processor, a memory, and the like. Specifically, the control device CTR is configured to be able to control the ranging function implemented by the ranging system RS. The control device CTR controls the movement of the light emitting device 100 and measures (calculates) the distance between the ranging system RS and the irradiated object using an image based on reflected light detected by the image sensor IS of the light receiving device 200. The ranging function in the present embodiment is achieved by the ToF method described above, but may be achieved by other methods. The control device CTR may be incorporated into either the light emitting device 100 or the light receiving device 200.

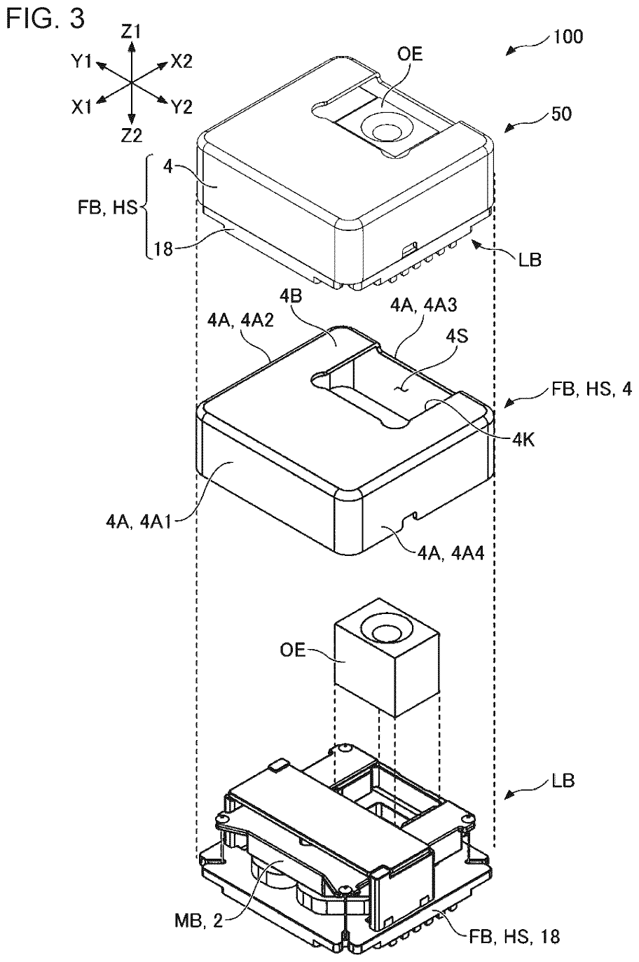

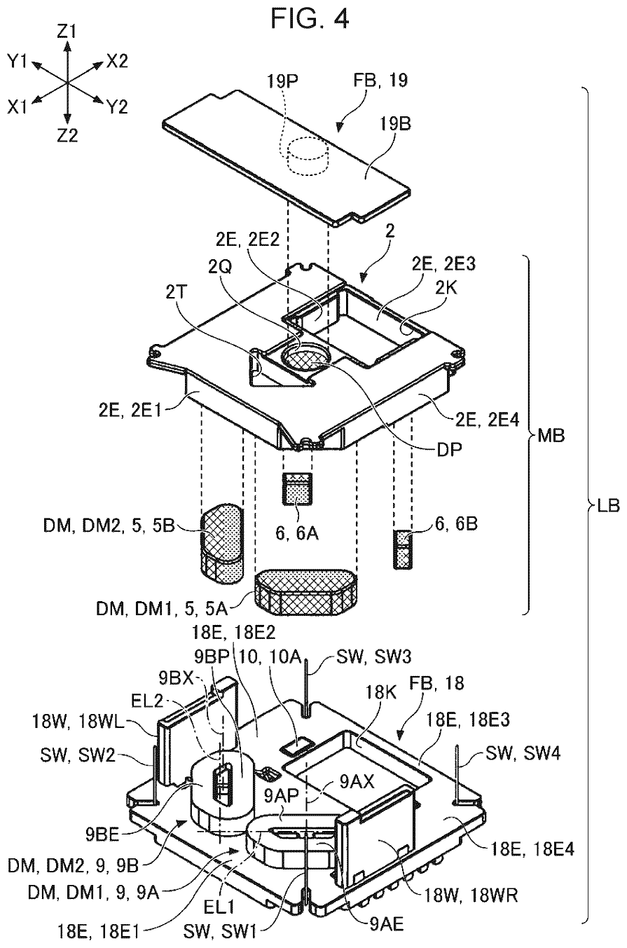

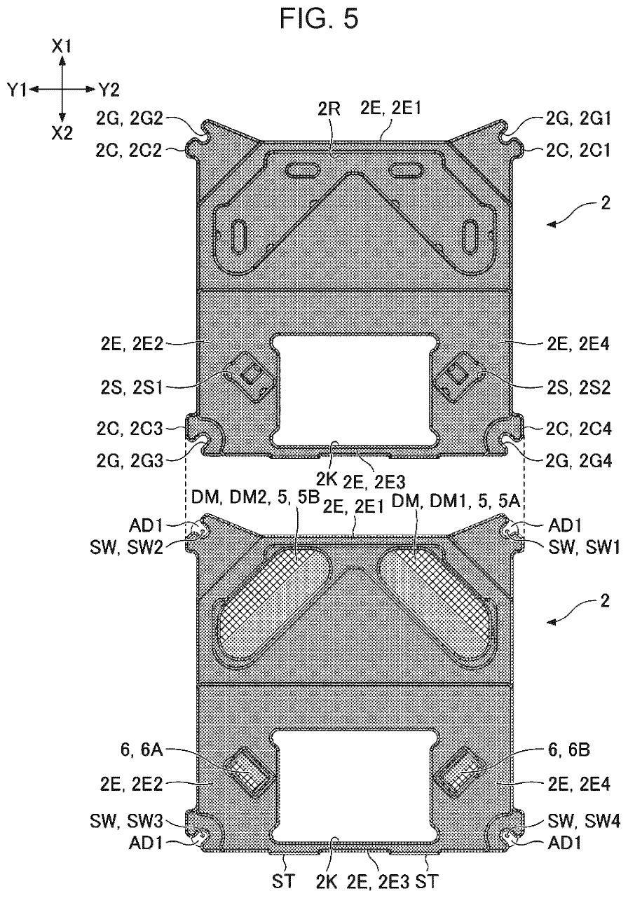

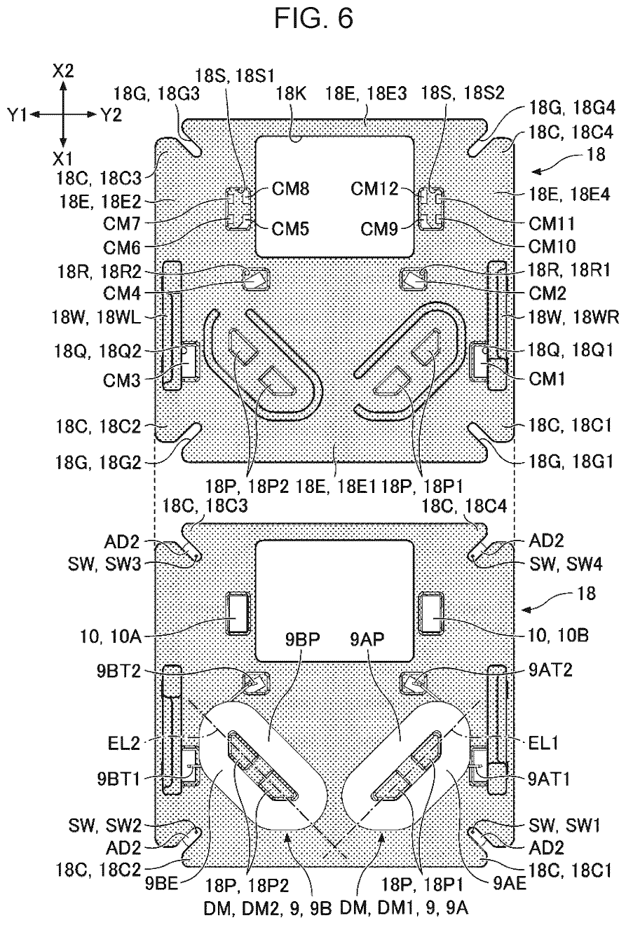

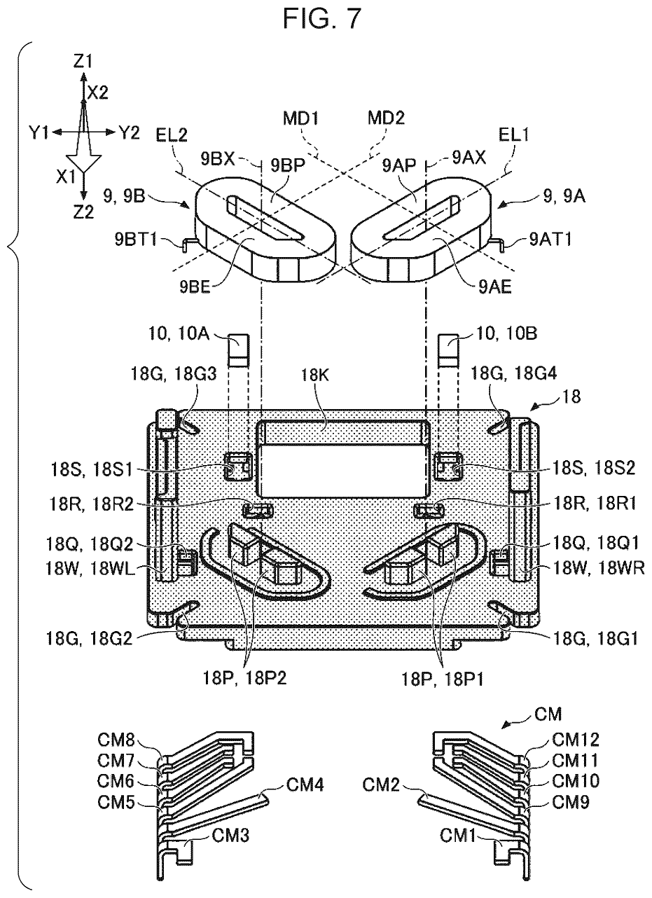

Next, referring to FIG. 3, the optical element drive device 50 according to the embodiment of the present disclosure will be described. FIG. 3 shows a perspective view of the light emitting device 100 including the optical element drive device 50. Specifically, the upper view in FIG. 3 is a perspective view of the light emitting device 100 including the optical element drive device 50 including a cover member 4 and a lower member LB. The lower view in FIG. 3 is an exploded perspective view of the light emitting device 100, showing the state in which the cover member 4 and the optical element OE are separated from the lower member LB. FIG. 4 is an exploded perspective view of the lower member LB, showing a movable member MB is separated from a fixing member FB. FIG. 5 is a bottom view of an optical element holding member 2 that constitutes the movable member MB. FIG. 6 is a top view of a base member 18 that constitutes the fixing member FB. FIG. 7 shows an exploded perspective view of the fixing member FB excluding the cover member 4.

The optical element drive device 50 is a device that moves the optical element OE in a virtual plane parallel to the XY plane. In FIG. 3, the optical element OF is represented as having a substantially rectangular shape for clarity, but it may have other shapes such as a cylinder.

Specifically, the optical element drive device 50 includes the lower member LB and a cover member 4, which is part of the fixing member FB, as shown in FIG. 3.

The cover member 4 is configured to be able to cover the upper part of the lower member LB. In the illustrated example, the cover member 4 is made by punching and drawing a plate material formed of a nonmagnetic metal such as aluminum. Because the cover member is formed of nonmagnetic metal, the cover member 4 does not have any adverse magnetic effects on a drive unit DM (see below), and the like, which uses electromagnetic force.

The cover member 4 has a covered rectangular tubular outline that defines a storage portion 4S, as shown in the lower view in FIG. 3. Specifically, the cover member 4 has a substantially rectangular tubular outer circumferential wall portion 4A and a substantially rectangular flat top plate portion 4B provided continuously with the upper end (Z1 side end) of the outer circumferential wall portion 4A. The top plate portion 4B has a substantially rectangular through hole 4K. The outer circumferential wall portion 4A includes a first side plate portion 4A1 to a fourth side plate portion 4A4. The first side plate portion 4A1 and the third side plate portion 4A3 face each other, and the second side plate portion 4A2 and the fourth side plate portion 4A4 face each other. The second side plate portion 4A2 and the fourth side plate portion 4A4 extend perpendicular to the first side plate portion 4A1 and the third side plate portion 4A3. The cover member 4 is joined to the base member 18 by adhesive to constitute, together with the base member 18, a housing HS, as shown in the upper view in FIG. 3.

The lower member LB includes a coil 9, a magnetic sensor 10, a base member 18, and a beam member 19, which are part of the fixing member FB, and the movable member MB, as shown in FIG. 4. The movable member MB includes the optical element holding member 2, a magnetic field generation member 5, and a detection magnet 6.

The coil 9 is a member constituting the drive unit DM. In the example shown in FIG. 4, the coil 9 is a wound type coil and includes a first coil 9A and a second coil 9B. The first coil 9A has a first coil axis 9AX extending in the Z axis direction, and the second coil 9B has a second coil axis 9BX extending in the Z axis direction. An insulating coating is applied to the wire rods that constitute the coil 9. In FIG. 4, details of the wire rods constituting the coil 9 are omitted for clarity. The same applies to the other figures including the coil 9. The coil 9 may be a stacked type or a film type. In other words, the coil 9 may be a coil formed by a circuit board pattern. In the illustrated example, the coil 9 is fixed to the base member 18 by adhesive, but it may be mounted on a circuit board such as a flexible circuit board, which is then fixed to the base member 18 by adhesive or the like.

The coil 9 has a linearly extending extension. Specifically, as shown in FIGS. 4, 6, and 7, the first coil 9A includes a first extension 9AE and a second extension 9AP that extend linearly along a first extension direction EL1 indicated by an alternate long and short dashed line. The second coil 9B includes a third extension 9BE and a fourth extension 9BP that extend linearly along a second extension direction EL2 indicated by an alternate long and short dashed line. In the illustrated example, the first extension 9AE constitutes the outer portion of the first coil 9A and the second extension 9AP constitutes the inner portion of the first coil 9A. Similarly, the third extension 9BE constitutes the outer portion of the second coil 9B and the fourth extension 9BP constitutes the inner portion of the second coil 9B. The “outer” means the side far from the center of the optical element drive device 50, and the “inner” means the side near the center of the optical element drive device 50. The same applies to the following description.

In the illustrated example, the first coil 9A is disposed so that the first extension direction EL1 is inclined by 45 degrees to the X axis in plan view along the vertical direction. The second coil 9B is disposed so that the second extension direction EL2 is perpendicular to the first extension direction EL1 in plan view along the vertical direction. Specifically, as shown in FIG. 6, the first coil 9A is disposed so that the first extension 9AE faces a first corner 18C1 of the base member 18, and the second coil 9B is disposed so that the third extension 9BE faces a second corner 18C2 of the base member 18.

The drive unit DM is configured to move the optical element OE along a direction perpendicular to the optical axis direction (Z axis direction). In the illustrated example, the drive unit DM includes a first drive unit DM1 that moves the optical element OE along a first drive direction MD1 perpendicular to the first extension direction EL1 and a second drive unit DM2 that moves the optical element OE along a second drive direction MD2 perpendicular to the second extension direction EL2, as shown in FIG. 7.

Specifically, as shown in FIG. 4, the first drive unit DM1 includes the first coil 9A installed on the base member 18 and the magnetic field generation member 5 (a first magnetic field generation member 5A) that is disposed facing the first coil 9A with a distance in the Z axis direction. The second drive unit DM2 includes the second coil 9B installed in the base member 18 and the magnetic field generation member 5 (a second magnetic field generation member 5B) that is disposed facing the second coil 9B with a distance in the Z axis direction.

The optical element drive device 50 with a substantially rectangular shape is mounted on the substrate 300, as shown in FIGS. 1 and 2. The coil 9 is then connected to a current supply source (current supply circuit) via the substrate 300. When a current flows through the coil 9, the drive unit DM generates an electromagnetic force along a direction parallel to the XY plane.

The magnetic field generation member 5, together with the coil 9, is a member constituting the drive unit DM. Specifically, the magnetic field generation member 5 is a member disposed facing the coil 9 in the vertical direction and includes the first magnetic field generation member 5A disposed facing the first coil 9A and the second magnetic field generation member 5B disposed facing the second coil 9B. In the illustrated example, the first magnetic field generation member 5A is a permanent magnet magnetized to two poles along the first drive direction MD1, and the second magnetic field generation member 5B is a permanent magnet magnetized to two poles along the second drive direction MD2. Specifically, as shown in FIG. 4, the outer portion of the first magnetic field generation member 5A is magnetized to the N pole and the inner portion is magnetized to the S pole. Similarly, the outer portion of the second magnetic field generation member 5B is magnetized to the N pole and the inner portion is magnetized to the S pole. In FIG. 4, for clarity of explanation, a portion magnetized to the N pole is indicated in a cross pattern and a portion magnetized to the S-pole is indicated in a dot pattern. The same applies to the other figures including the magnetic field generation member 5. However, the first magnetic field generation member 5A may have a configuration in which two permanent magnets magnetized to two poles along the vertical direction (Z axis direction) are disposed side by side along the first drive direction MD1, or a configuration of a permanent magnet magnetized to four poles. The same applies to the second magnetic field generation member 5B.

The detection magnet 6 is used to detect the displacement of the optical element OE. In the illustrated example, the detection magnet 6 includes a first detection magnet 6A used to detect the displacement of the optical element OE in the first drive direction MD1, and a second detection magnet 6B used to detect the displacement of the optical element OE in the second drive direction MD2. In the illustrated example, the first detection magnet 6A is a permanent magnet magnetized to two poles along the first drive direction MD1, and the second detection magnet 6B is a permanent magnetized to two poles along the second drive direction MD2. Specifically, as shown in FIG. 4, the outer portion of the first detection magnet 6A is magnetized to the N pole and the inner portion is magnetized to the S pole. Similarly, the outer portion of the second detection magnet 6B is magnetized to the N pole and the inner portion is magnetized to the S pole. In FIG. 4, for clarity of explanation, a portion magnetized to the N pole is indicated in a cross pattern and a portion magnetized to the S-pole is indicated in a dot pattern. The same applies to the other figures including the detection magnet 6.

The magnetic sensor 10 detects the displacement of the movable member MB (optical element OE) by detecting the magnetism generated by the detection magnet 6 attached to the movable member MB. In the illustrated example, the magnetic sensor 10 includes a first magnetic sensor 10A that detects the displacement of the movable member MB (the optical element OE) in the first drive direction MD1 by detecting magnetism generated by the first detection magnet 6A attached to the movable member MB, and a second magnetic sensor 10B that detects the displacement of the movable member MB (the optical element OE) in the second drive direction MD2 by detecting magnetism generated by the second detection magnet 6B attached to the movable member MB.

In the illustrated example, the magnetic sensor 10 includes a Hall element, and is configured to be able to detect the position of the movable member MB including the detection magnet 6 by measuring an output voltage, of the Hall element, that varies according to the magnitude of the magnetic field, from the detection magnet 6, that the Hall element receives. The magnetic sensor 10 may be configured to be able to detect the position of the optical element OE using a magneto resistive element such as a giant magneto resistive effect (GMR) element, a semiconductor magneto resistive (SMR) element, an anisotropic magneto resistive (AMR) element, a tunnel magneto resistive (TMR) element, or the like.

The optical element holding member 2 is a member for holding the optical element OE. In the present embodiment, the optical element holding member 2 is configured to hold the optical element OE, the magnetic field generation member 5, and the detection magnet 6. In the illustrated example, the optical element holding member 2 is formed by injection molding a synthetic resin such as liquid crystal polymer (LCP). The optical element holding member 2 includes a penetration 2K formed to extend parallel to the Z axis, as shown in FIG. 4. The optical element OE is fixed to the inner face of the penetration 2K with adhesive. The penetration 2K may be a cutout (for example, a structure of defining an open space with one of the front, back, left, and right walls omitted), instead of a through hole (a structure defining a space surrounded by the front, back, and right walls) as shown in the figure.

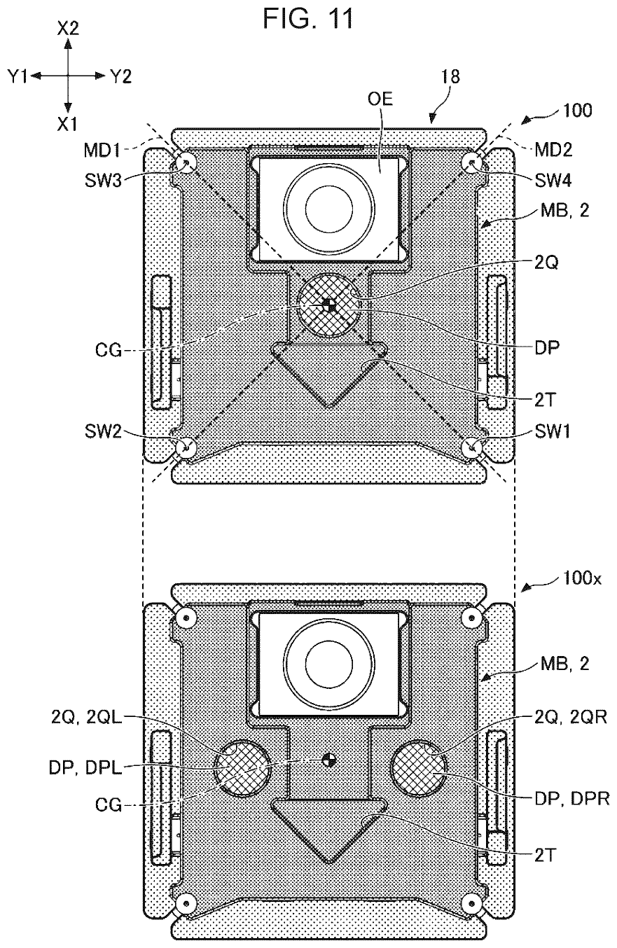

As shown in FIG. 4, the upper (Z1 side) end face of the optical element holding member 2 has a bottomed cylindrical accommodation portion 20 recessed in the Z2 direction and a bottomed triangular-column-shaped center of gravity adjustment portion 2T recessed in the Z2 direction. The accommodation portion 20 is a portion that accommodates a damping material DP that constitutes the damping mechanism that suppresses vibration of the optical element holding member 2. In the illustrated example, the damping material DP is an ultraviolet-curable gel-like material. In FIG. 4, for clarity, the damping material DP accommodated in the accommodation portion 20 is marked with a cross pattern. The center of gravity adjustment portion 2T is a structure for adjusting the weight balance of the optical element holding member 2, the structure being provided so that a center of gravity CG (see FIG. 11) of the movable member MB to which the optical element OE is attached is located within the accommodation portion 20. In the illustrated example, the center of gravity adjustment portion 2T is configured to define a triangular-column-shaped space, but it may be configured to define a space of another shape, such as a cylinder or a square cylinder. The center of gravity adjustment portion 2T may be a penetration such as a through hole or a cutout, or a projection protruding from the surface of the optical element holding member 2. The center of gravity adjustment portion 2T may be omitted.

Referring now to FIG. 5, details of the optical element holding member 2 will be explained. FIG. 5 is a bottom view of the optical element holding member 2. Specifically, the upper view in FIG. 5 shows the bottom view of the optical element holding member 2 before the optical element OE, the magnetic field generation member 5, the detection magnet 6, and a suspension wire SW are attached, and the lower view in FIG. 5 shows the bottom view of the optical element holding member 2 after the magnetic field generation member 5, the detection magnet 6, and the suspension wire SW are attached.

In the illustrated example, the optical element holding member 2 is a substantially rectangular ring-shaped frame. Four sides 2E constituting the frame include a first side 2E1 to a fourth side 2E4. Then, corners 2C are provided between the four sides 2E, and the corners 2C include a first corner 2C1 to a fourth corner 2C4. Specifically, the first corner 2C1 is provided between the first side 2E1 and the fourth side 2E4, the second corner 202 is provided between the first side 2E1 and the second side 2E2, the third corner 2C3 is provided between the second side 2E2 and the third side 2E3, and the fourth corner 2C4 is provided between the third side 2E3 and the fourth side 2E4. Each of the four corners 2C (the first corner 201 to the fourth corner 2C4) has a groove 2G (a first groove 2G1 to a fourth groove 2G4) for holding the metal suspension wire SW (a first wire SW1 to a fourth wire SW4).

Suspension wire SW is an example of an elastic support member and is configured to allow the movable member MB (the optical element holding member 2) to move in the XY plane with respect to the fixing member FB (the base member 18). In the illustrated example, the suspension wires SW include the first wire SW1 to the fourth wire SW4. The upper end of the first wire SW1 is fixed to the optical element holding member 2 by an adhesive AD1 in a state in which the upper end is inserted into the first groove 2G1. Similarly, the upper end of the second wire SW2 is fixed to the optical element holding member 2 by the adhesive AD1 in a state in which the upper end is inserted into the second groove 2G2, the upper end of the third wire SW3 is fixed to the optical element holding member 2 by the adhesive AD1 in a state in which the upper end is inserted into the third groove 2G3, the upper end of the fourth wire SW4 is fixed to the optical element holding member 2 by the adhesive AD1 in a state in which the upper end is inserted into the fourth groove 2G4. The upper end of the suspension wire SW may be fixed by solder, adhesive or the like to a metal plate fixed by adhesive or the like to the top surface of the optical element holding member 2 made of synthetic resin.

The lower (Z2 side) end face of the optical element holding member 2 has an accommodation portion 2R recessed in the Z1 direction, as shown in the upper view in FIG. 5. The accommodation portion 2R accommodates the magnetic field generation member 5, as shown in the lower view in FIG. 5. The magnetic field generation member 5 is fixed to the optical element holding member 2 with adhesive. In the illustrated example, is configured to accommodate the first magnetic field generation member 5A and the second magnetic field generation member 5B, but the accommodation portion 2R may be separated into a portion that accommodates the first magnetic field generation member 5A and a portion that accommodates the second magnetic field generation member 5B. In other words, the accommodation portion 2R may have two recesses. The accommodation portion 2R may be open not only on the lower side but also on the side, or may be formed to penetrate the optical element holding member 2.

The lower (Z2 side) end face of the optical element holding member 2 has an accommodation portion 2S recessed in the Z1 direction, as shown in the upper view in FIG. 5. The accommodation portion 2S accommodates the detection magnet 6, as shown in the lower view in FIG. 5. Specifically, the accommodation portion 2S includes a first accommodation portion 2S1 in which the first detection magnet 6A is accommodated and a second accommodation portion 2S2 in which the second detection magnet 6B is accommodated. The detection magnet 6 is fixed to the optical element holding member 2 with adhesive.

The base member 18 is configured to hold the coil 9 and the magnetic sensor 10. In the illustrated example, the base member 18 is formed by injection molding a synthetic resin such as liquid crystal polymer (LCP). The base member 18 includes a penetration 18K formed to correspond to the penetration 2K of the optical element holding member 2 and to extend parallel to the Z axis, as shown in FIG. 4. The penetration 18K, like the penetration 2K, can be a cutout as well as a through hole as shown in the figure.

The rear (X2 side) end face of the optical element holding member 2 has a pair of stopper portions ST protruding in the X2 direction, as shown in the lower view in FIG. 5. The stopper portion ST is a portion for restricting the amount of movement of the optical element holding member 2 in the X2 direction. Specifically, when the movable member MB (the optical element holding member 2) moves in the X2 direction with respect to the fixing member FB (the base member 18), the stopper portion ST is configured to contact the inner face of the third side plate portion 4A3 of the cover member 4 as the fixing member FB and prevent the movable member MB (the optical element holding member 2) from moving further in the X2 direction.

Next, referring to FIG. 6, details of the base member 18 will be described. FIG. 6 shows a top view of the base member 18. Specifically, the upper view in FIG. 6 is a top view of the base member 18 before the coil 9, the magnetic sensor 10, and the suspension wire SW are installed, and the lower view in FIG. 6 is a top view of the base member 18 after the coil 9, the magnetic sensor 10, and the suspension wire SW are installed.

In the illustrated example, the base member 18 is a substantially rectangular ring-shaped frame, as shown in FIG. 6. Four sides 18E constituting the frame include a first side 18E1 to a fourth side 18E4. Then, corners 18C are provided between the four sides 18E, and the corners 18C include a first corner 18C1 to a fourth corner 18C4. Specifically, the first corner 18C1 is provided between the first side 18E1 and the fourth side 18E4, the second corner 18C2 is provided between the first side 18E1 and the second side 18E2, the third corner 18C3 is provided between the second side 18E2 and the third side 18E3, and the fourth corner 18C4 is provided between the third side 18E3 and the fourth side 18E4. Each of the four corners 18C (the first corner 18C1 to the fourth corner 18C4) has a groove 18G (a first groove 18G1 to a fourth groove 18G4) for holding the suspension wire SW (the first wire SW1 to the fourth wire SW4).

The lower end of the first wire SW1 is fixed to the base member 18 by an adhesive AD2 in a state where the lower end is inserted into the first groove 18G1. Similarly, the lower end of the second wire SW2 is fixed to the base member 18 by the adhesive AD2 in a state where the lower end is inserted into the second groove 18G2, the lower end of the third wire SW3 is fixed to the base member 18 by the adhesive AD2 in a state where the lower end is inserted into the third groove 18G3, the lower end of the fourth wire SW4 is fixed to the base member 18 by the adhesive AD2 in a state where the lower end is inserted into the fourth groove 18G4.

In a case where the coil 9 is mounted on a circuit board such as a flexible circuit board and the circuit board is fixed to the base member 18 by adhesive or the like, the lower end of the suspension wire SW may be fixed to the circuit board by solder, adhesive or the like.

In the illustrated example, the coil 9 and the magnetic sensor 10 are fixed to the Z1 side top surface of the base member 18 by adhesive, and the substrate 300 is fixed to the Z2 side undersurface of the base member 18 by adhesive. A metallic conductive member CM is embedded in the base member 18, as shown in FIG. 7. The conductive member CM is used to supply power to each of the coils 9 and the magnetic sensors 10. Specifically, the conductive member CM includes a first conductive member CM1 to a twelfth conductive member CM12.

As shown in the upper view in FIG. 6, the top surface of the base member 18 has an accommodation portion 18S that accommodates the magnetic sensor 10. The accommodation portion 18S includes a first accommodation portion 18S1 that accommodates the first magnetic sensor 10A and a second accommodation portion 1882 that accommodates the second magnetic sensor 10B. The first accommodation portion 18S1 is configured so that a portion of each of the fifth conductive member CM5 to the eighth conductive member CM8 is exposed at its bottom, and the second accommodation portion 18S2 is configured so that a portion of each of the ninth conductive member CM9 to the twelfth conductive member CM12 is exposed at its bottom. With this configuration, the fifth conductive member CM5 to the eighth conductive member CM8 are connected to the four terminals of the first magnetic sensor 10A accommodated in the first accommodation portion 18S1, and the ninth conductive members CM9 to the twelfth conductive member CM12 are connected to the four terminals of the second magnetic sensor 10B accommodated in the second accommodation portion 18S2. The connection between the terminals of the magnetic sensor 10 and the conductive member CM is made by solder or conductive adhesive.

As shown in the upper view in FIG. 6, the top surface of the base member 18 has a projection 18P to which the coil 9 is fixed. The projection 18P includes a first projection 18P1 to which the first coil 9A is fixed and a second projection 18P2 to which the second coil 9B is fixed.

As shown in the upper view in FIG. 6, the top surface of the base member 18 has a recess 180 and a recess 18R that receive the ends of the wire rods constituting the coil 9. Specifically, the recess 180 includes a first recess 1801 that receives a first end 9AT1, which is one end of the first coil 9A, and a second recess 1802 that receives a first end 9BT1, which is one end of the second coil 9B. The recess 18R includes a first recess 18R1 that receives a second end 9AT2, which is the other end of the first coil 9A, and a second recess 18R2 that receives a second end 9BT2, which is the other end of the second coil 9B. The first recess 1801 is configured so that a portion of the first conductive member CM1 is exposed at its bottom, the first recess 18R1 is configured so that a portion of the second conductive member CM2 is exposed at its bottom, the second recess 1802 is configured so that a portion of the third conductive member CM3 is exposed at its bottom, and the second recess 18R2 is configured so that a portion of the fourth conductive member CM4 is exposed at its bottom. With this configuration, the first conductive member CM1 is connected to the first end 9AT1 of the first coil 9A inserted in the first recess 18Q1, and the second conductive member CM2 is connected to the second end 9AT2 of the first coil 9A inserted in the first recess 18R1. The third conductive member CM3 is connected to the first end 9BT1 of the second coil 9B inserted in the second recess 1802, and the fourth conductive member CM4 is connected to the second end 9BT2 of the second coil 9B inserted in the second recess 18R2. The connection between the end of the coil 9 and the conductive member CM is made by solder or conductive adhesive.

The top surface of the base member 18 has a pair of walls 18W used to support the beam member 19. The pair of walls 18W includes a left wall 18WL and a right wall 18WR.

The beam member 19 is part of the fixing member FB that constitutes a damping mechanism that suppresses vibration of the optical element holding member 2. In the illustrated example, the beam member 19 is made of translucent synthetic resin material. The beam member 19 is fixed to the pair of walls 18W with adhesive after the liquid damping material DP is applied (poured) into the accommodation portion 20. The beam member 19 is fixed to the pair of walls 18W and is exposed to ultraviolet radiation from above. The damping material DP accommodated in the accommodation portion 20 is cured into a gel by receiving ultraviolet rays that pass through the beam member 19.

Specifically, as shown in FIG. 4, the beam member 19 includes a plate-shaped base portion 19B and a protrusion 19P formed to protrude downward from the undersurface of the base portion 19B. The protrusion 19P protrudes downward so that its distal end enters the accommodation portion 20 provided on the top surface of the optical element holding member 2 in a case where the base portion 19B is fixed to the pair of walls 18W, and the distal end is in contact with the damping material DP accommodated in the accommodation portion 20. With this configuration, the protrusion 19P and the damping material DP achieve a damping mechanism that suppresses the vibration of the optical element holding member 2 and dampens the vibration of the optical element holding member 2 at an early stage.

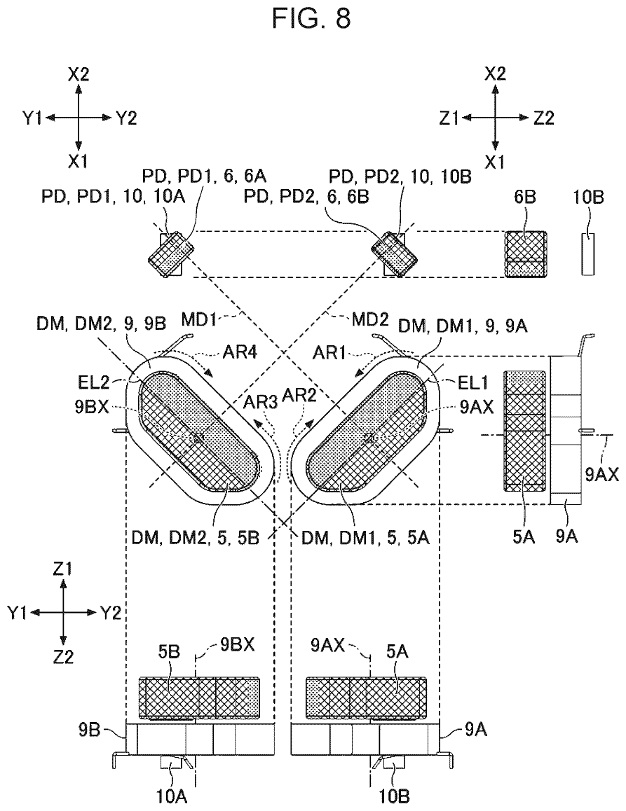

Next, referring to FIG. 8, the positional relationship of the magnetic field generation member 5, the detection magnet 6, the coil 9, and the magnetic sensor 10, which constituting the magnetic system including the drive unit DM, will be described. FIG. 8 shows a three-view (front view, top view, and right side view) of the magnetic system mounted on the optical element drive device 50. A magnetic system is a system that uses magnetic force and includes the drive unit DM and a position detection unit PD. In FIG. 8, for clarity of explanation, components other than the magnetic field generation member 5, the detection magnet 6, the coil 9, and the magnetic sensor 10 are omitted.

The drive unit DM is a means for moving the optical element OE in the XY plane. In the illustrated example, the drive unit DM includes the first drive unit DM1 that moves the optical element OE along the first drive direction MD1 and the second drive unit DM2 that moves the optical element OE along the second drive direction MD2.

As shown in FIG. 4, the first drive unit DM1 includes the first coil 9A provided on the base member 18 and the first magnetic field generation member 5A disposed facing the first coil 9A with a distance in the Z axis direction. The first magnetic field generation member 5A and the first coil 9A are disposed facing each other with a slight space therebetween, as shown in the front view and the right side view in FIG. 8.

As shown in FIG. 4, the second drive unit DM2 includes a second coil 9B provided on the base member 18 and a second magnetic field generation member 5B disposed facing the second coil 9B with a distance in the Z axis direction. As shown in the front view in FIG. 8, the second magnetic field generation member 5B and the second coil 9B are disposed facing each other with a slight space therebetween.

When current flows in the first coil 9A in the direction indicated by a dashed arrow AR1 in FIG. 8, the optical element holding member 2 (the first magnetic field generation member 5A) moves right forward along the first drive direction MD1 with respect to the base member 18 while being supported by the suspension wire SW. When current flows in the first coil 9A in the direction indicated by a dashed arrow AR2 in FIG. 8, the optical element holding member 2 (the first magnetic field generation member 5A) moves left backward along the first drive direction MD1 with respect to the base member 18 while being supported by the suspension wire SW. This is because the Lorentz force acts on the charged particles moving in the wire rods that constitutes the first coil 9A fixed to the base member 18, and the reaction force causes the first magnetic field generation member 5A to move right forward or left backward along the first drive direction MD1. This is because the first driving force, which is the force to move the first magnetic field generation member 5A right forward along the first drive direction MD1, or the second driving force, which is the force to move the first magnetic field generation member 5A left backward along the first drive direction MD1, acts on the optical element holding member 2.

Similarly, when current flows in the second coil 9B in the direction indicated by a dashed arrow AR3 in FIG. 8, the optical element holding member 2 (the second magnetic field generation member 5B) moves left forward along the second drive direction MD2 toward the base member 18 while being supported by the suspension wire SW. When current flows in the second coil 9B in the direction indicated by a dashed arrow AR4 in FIG. 8, the optical element holding member 2 (the second magnetic field generation member 5B) moves right backward along the second drive direction MD2 with respect to the base member 18 while being supported by the suspension wire SW. This is because the Lorentz force acts on the charged particles moving in the wire rods that makes up the second coil 9B fixed to the base member 18, and the reaction force causes the second magnetic field generation member 5B to move left forward or right backward. This is because the third driving force, which is the force to move the second magnetic field generation member 5B left forward along the second drive direction MD2, or the fourth driving force, which is the force to move the second magnetic field generation member 5B right backward along the second drive direction MD2, acts on the optical element holding member 2.

The control device CTR can move the optical element holding member 2 (the first magnetic field generation member 5A and the second magnetic field generation member 5B) forward (X1 direction) with respect to the base member 18 by applying current to the first coil 9A in the direction indicated by the dashed arrow AR1 and applying current to the second coil 9B in the direction indicated by the dashed arrow AR3. This is because the first driving force that moves the first magnetic field generation member 5A right forward along the first drive direction MD1 and the third driving force that moves the second magnetic field generation member 5B left forward along the second drive direction MD2 act simultaneously on the optical element holding member 2. In this case, the moving speed of the optical element holding member 2 is greater than that when the optical element holding member 2 is driven only by the first driving force or the third driving force.

The control device CTR can move the optical element holding member 2 (the first magnetic field generation member 5A and the second magnetic field generation member 5B) right (Y2 direction) with respect to the base member 18 by applying current to the first coil 9A in the direction indicated by the dashed arrow AR1 and applying current to the second coil 9B in the direction indicated by the dashed arrow AR4. This is because the first driving force that moves the first magnetic field generation member 5A right forward along the first drive direction MD1 and the fourth driving force that moves the second magnetic field generation member 5B right backward along the second drive direction MD2 act simultaneously on the optical element holding member 2. In this case, the moving speed of the optical element holding member 2 is greater than that when the optical element holding member 2 is driven only by the first driving force or the fourth driving force.

The control device CTR can move the optical element holding member 2 (the first magnetic field generation member 5A and the second magnetic field generation member 5B) left (Y1 direction) with respect to the base member 18 by applying current to the first coil 9A in the direction shown by the dashed arrow AR2 and applying current to the second coil 9B in the direction shown by the dashed arrow AR3. This is because the second driving force that moves the first magnetic field generation member 5A left backward along the first drive direction MD1 and the third driving force that moves the second magnetic field generation member 5B left forward along the second drive direction MD2 act simultaneously on the optical element holding member 2. In this case, the moving speed of the optical element holding member 2 is greater than that when the optical element holding member 2 is driven only by the second driving force or the third driving force.

The control device CTR can move the optical element holding member 2 (the first magnetic field generation member 5A and the second magnetic field generation member 5B) backward (X2 direction) with respect to the base member 18 by applying current to the first coil 9A in the direction shown by the dashed arrow AR2 and applying current to the second coil 9B in the direction shown by the dashed arrow AR4. This is because the second driving force that moves the first magnetic field generation member 5A left backward along the first drive direction MD1 and the fourth driving force that moves the second magnetic field generation member 5B right backward along the second drive direction MD2 act simultaneously on the optical element holding member 2. In this case, the moving speed of the optical element holding member 2 is greater than that when the optical element holding member 2 is driven only by the second driving force or the fourth driving force.

The control device CTR can move the optical element holding member 2 (the first magnetic field generation member 5A and the second magnetic field generation member 5B) in any direction on the XY plane with respect to the base member 18 by adjusting, for example, the magnitude of the current flowing through each of the first coil 9A and the second coil 9B, that is, by adjusting the magnitude of each of the first driving force, the second driving force, the third driving force, and the fourth driving force.

The position detection unit PD is a means for detecting the position of the optical element OF fixed to the optical element holding member 2. In the illustrated example, the position detection unit PD is configured to be able to detect the position of the optical element OE fixed to the optical element holding member 2 in a virtual plane parallel to the XY plane. Specifically, the position detection unit PD includes a first position detection unit PD1 that detects the position of the optical element OE in the first drive direction MD1 and a second position detection unit PD2 that detects the position of the optical element OE in the second drive direction MD2.

As shown in the front view and the right side view in FIG. 8, the first position detection unit PD1 includes the first detection magnet 6A and the first magnetic sensor 10A that are spaced apart from each other in the vertical direction. As shown in the front view and the right side view in FIG. 8, the second position detection unit PD2 includes the second detection magnet 6B and the second magnetic sensor 10B that are spaced apart from each other in the vertical direction.

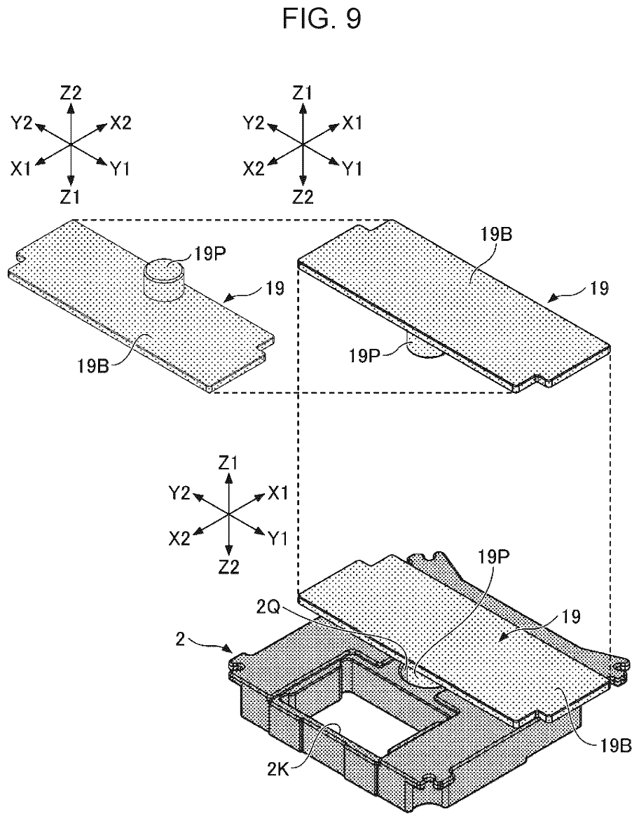

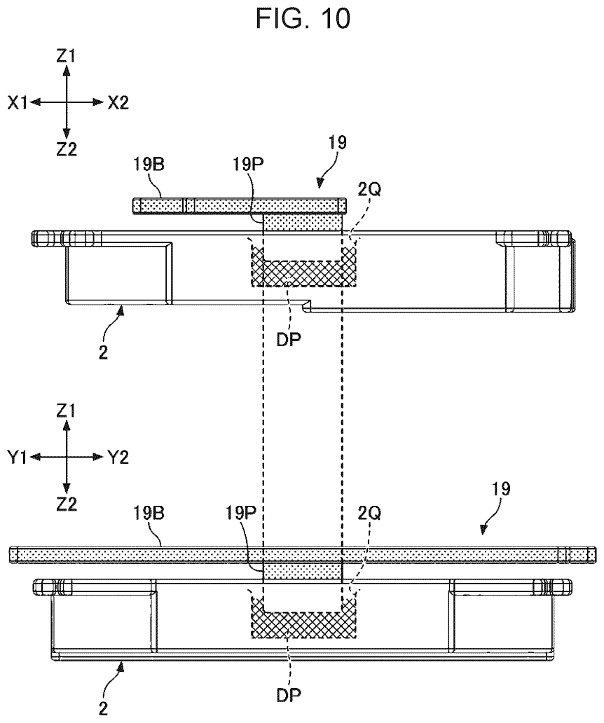

Next, referring to FIGS. 9 and 10, the damping mechanism that suppresses vibration of the optical element holding member 2 will be described. FIG. 9 shows a perspective view of the optical element holding member 2 and the beam member 19. Specifically, the left upper view in FIG. 9 is a perspective view of the beam member 19 viewed from the Z2 side, the right upper view in FIG. 9 is a perspective view of the beam member 19 viewed from the Z1 side, and the right lower view (lower view) in FIG. 9 is a perspective view of the optical element holding member 2 and the beam member 19 viewed from the Z1 side. FIG. 10 shows a side view of the optical element holding member 2 and the beam member 19. Specifically, the upper view in FIG. 10 is a right side view of the optical element holding member 2 and the beam member 19, and the lower view in FIG. 10 is a front view of the optical element holding member 2 and the beam member 19. In FIG. 9, for clarity of explanation, the beam member 19 is marked with a coarse dot pattern and the optical element holding member 2 is marked with a fine dot pattern. In FIG. 10, the beam member 19 is marked with a coarse dot pattern, the accommodation portion 20 formed on the top surface of the optical element holding member 2, which is actually invisible, and the distal end of the protrusion 19P inserted into the accommodation portion 20 is indicated in a dashed line, and the damping material DP accommodated in the accommodation portion 20, which is actually invisible, is marked with a cross pattern. In FIGS. 9 and 10, members other than the optical element holding member 2 and the beam member 19 are not illustrated.

As shown in the right lower view (lower view) in FIG. 9 and FIG. 10, the distal end of the protrusion 19P of the beam member 19 is inserted into the accommodation portion 20 of the optical element holding member 2 with the liquid damping material DP poured into the accommodation portion 2Q. Specifically, the protrusion 19P is inserted into the accommodation portion 20 so that its distal end is inserted into the liquid damping material DP and the liquid damping material DP is also attached to its periphery, as shown in FIG. 10.

The liquid damping material DP is then cured by ultraviolet radiation to form a gel. In the illustrated example, the beam member 19 is made of translucent synthetic resin material, so the liquid damping material DP is irradiated with ultraviolet light in a state where the distal end of the protrusion 19P is inserted into the accommodation portion 2Q. This ultraviolet light passes through the beam member 19 and the liquid damping material DP accommodated in the accommodation portion 20 is irradiated with the ultraviolet light. With this configuration, the liquid damping material DP is gelatinized with the distal end of the protrusion 19P inserted.

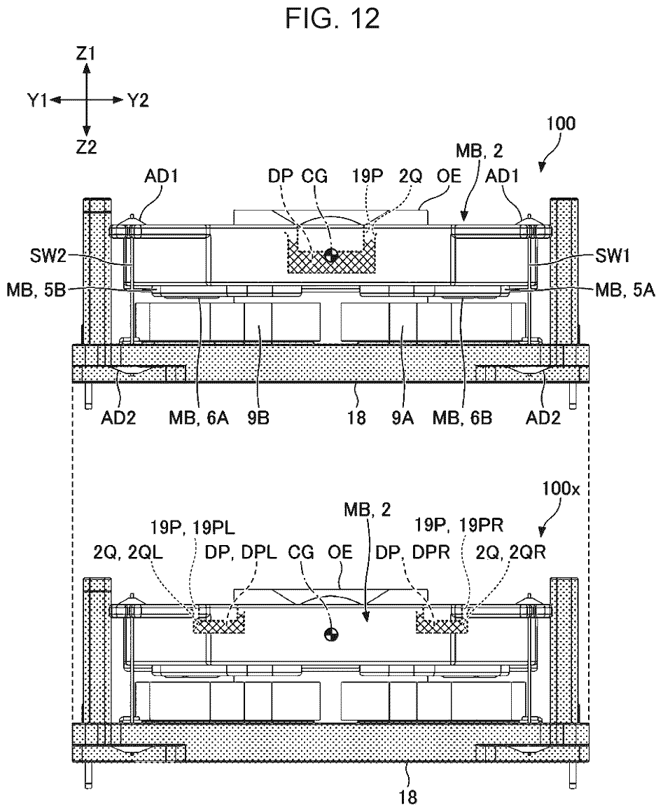

Next, referring to FIGS. 11 and 12, the position of the center of gravity CG of the movable member MB to which the optical element OE is attached will be described. FIG. 11 shows a top view of the light emitting device 100 with the cover member 4 and the beam member 19 removed. Specifically, the upper view in FIG. 11 is a top view of the light emitting device 100 according to the embodiment described above, and the lower view in FIG. 11 is a top view of a light emitting device 100x that is another configuration example of the light emitting device 100. FIG. 12 shows a front view of the light emitting device 100 with the cover member 4 and the beam member 19 removed. Specifically, the upper view in FIG. 12 is a front view of the light emitting device 100 according to the embodiment described above, and the lower view in FIG. 12 is a front view of the light emitting device 100x shown in the lower view in FIG. 11. In FIG. 11, for clarity of explanation, the base member 18 is marked with a coarse dot pattern and the optical element holding member 2 is marked with a fine dot pattern. In FIG. 12, the base member 18 is marked with a coarse dot pattern, the accommodation portion 20 formed on the top surface of the optical element holding member 2, which is actually invisible, and the distal end of the protrusion 19P inserted into the accommodation portion 2Q are indicated in dashed lines, and the vibration damping material DP accommodated in the accommodation portion 20, which is actually invisible, is marked with a cross pattern.

The light emitting device 100x differs from the light emitting device 100 in that two accommodation portions 20 are formed on the top surface of the optical element holding member 2 and two protrusions 19P are formed on the undersurface of the beam member 19, but is otherwise the same as the light emitting device 100. Specifically, the accommodation portion 20 formed on the top surface of the optical element holding member 2 of the light emitting device 100x includes a left accommodation portion 2QL and a right accommodation portion 2QR, as shown in the lower view in FIG. 11. The protrusion 19P formed on the undersurface of the beam member 19 of the light emitting device 100x includes a left protrusion 19PL and a right protrusion 19PR, as shown in the lower view in FIG. 12. As shown in the lower view in FIG. 12, the left accommodation portion 2QL accommodates a left damping material DPL and the right accommodation portion 2QR accommodates a right damping material DPR.

As shown in the upper view in FIG. 11 and the upper view in FIG. 12, in the light emitting device 100, the optical element holding member 2 is configured so that, in plan view along the vertical direction, the center of gravity CG of the movable member MB to which the optical element OE is attached, that is, the center of gravity CG of the optical element holding member 2 to which the optical element OE, the magnetic field generation member 5, and the detection magnet 6 are attached is located within the accommodation portion 2Q. In the illustrated example, the optical element holding member 2 is configured so that the position and the size of the center of gravity adjustment portion 2T is adjusted and the center of gravity CG is positioned at the approximate center of the accommodation portion 20, as shown in the upper view in FIG. 11.

With this configuration, the damping mechanism including the protrusion 19P and the damping material DP can efficiently dampen the vibration of the movable member MB with respect to the fixing member FB. This is because the center of vibration substantially matches the position of the center of gravity CG. In the example shown in the upper view of FIG. 11, the light emitting device 100 is configured so that, in plan view, a straight line passing through the first wire SW1, the damping material DP, and the third wire SW3 is parallel to or matches the first drive direction MD1, and a straight line passing through the second wire SW2, the damping material DP, and the fourth wire SW4 is parallel to or matches the second drive direction MD2. Therefore, the light emitting device 100 can stabilize transient response characteristics.

As shown in the lower view in FIG. 11 and the lower view in FIG. 12, in the light emitting device 100x, the optical element holding member 2 is configured so that the center of gravity CG of the movable member MB to which the optical element OE is attached is located between a left accommodation portion 2QL and a right accommodation portion 2QR in plan view along the vertical direction. In the illustrated example, the optical element holding member 2 is configured so that the center of gravity CG is located at the approximate midpoint between the left accommodation portion 2QL and the right accommodation portion 2QR, as shown in the lower view in FIG. 11.

With this configuration, the damping mechanism including the left protrusion 19PL, the right protrusion 19PR, the left damping material DPL, and the right damping material DPR can efficiently dampen the vibration of the movable member MB with respect to the fixing member FB. This is because the center of vibration substantially matches the position of the center of gravity CG.

The accommodation portion 20 where the damping material DP is accommodated may be formed at any other location, and the number of the accommodation portion 20 may be three or more. The same applies to the protrusion 19P. For example, the accommodation portion 20 where the damping material DP is accommodated is disposed in front (X1 side) of a portion where the optical element OE is disposed in the illustrated example, but the accommodation portion 20 may be disposed at least one of left (Y1 side) and right (Y2 side) of a portion where the optical element OE is disposed or may be disposed rear (X2 side) of a portion where the optical element OF is disposed. The accommodation portion where the damping material is accommodated may be formed in the fixing member FB. In this case, the protrusion that enters the accommodation portion may be formed on the movable member MB.

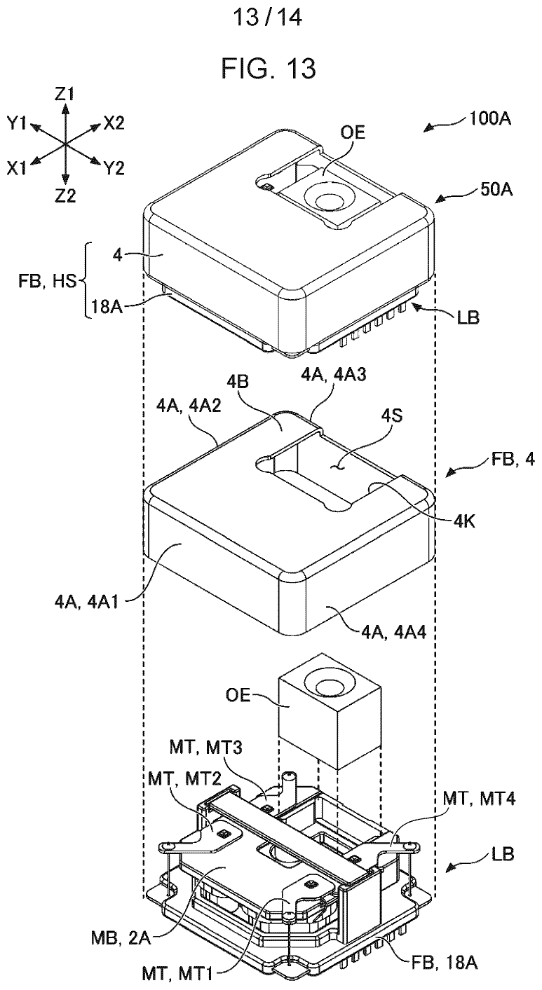

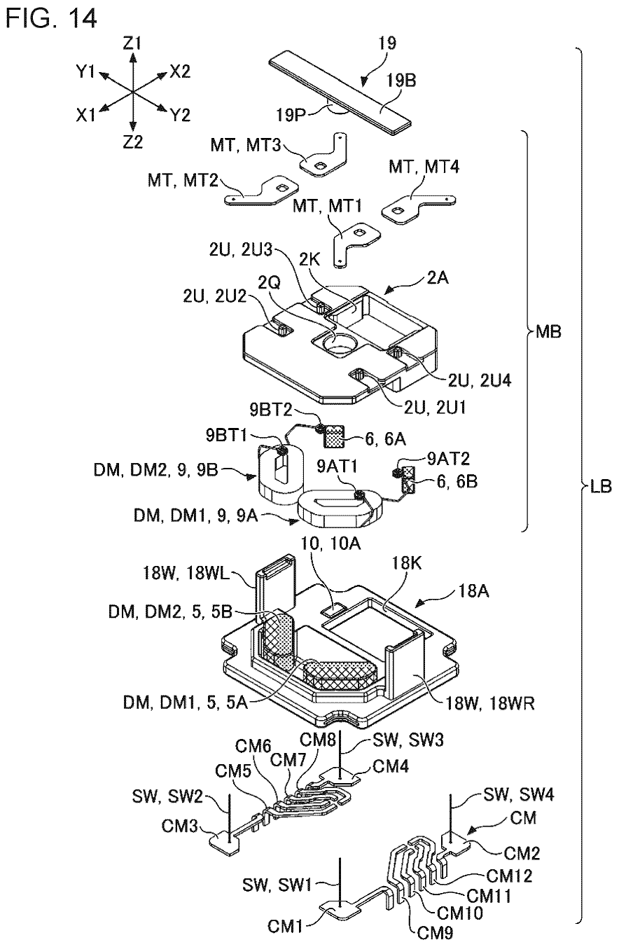

Next, referring to FIGS. 13 and 14, a light emitting device 100A, which is another configuration example of the light emitting device 100, will be described. FIG. 13 shows a perspective view of the light emitting device 100A, corresponding to FIG. 3. Specifically, the upper view in FIG. 13 is a perspective view of the light emitting device 100A including an optical element drive device 50A that is another configuration example of the optical element drive device 50 including the cover member 4 and the lower member LB. The lower view in FIG. 13 is an exploded perspective view of the light emitting device 100A, showing the state in which the cover member 4 and the optical element OE are separated from the lower member LB. FIG. 14 shows an exploded perspective view of the lower member LB constituting the optical element drive device 50A, corresponding to FIG. 4. Specifically, FIG. 14 shows the state in which the movable member MB is separated from the fixing member FB.

The optical element drive device 50A differs from the optical element drive device 50 mainly in that the coil 9 is attached to an optical element holding member 2A, which is another configuration example of the optical element holding member 2 that is part of the movable member MB, and the magnetic field generation member 5 is attached to the base member 18A, which is another configuration example of the base member 18 that is part of the fixing member FB, but is otherwise the same as the optical element drive device 50.

Specifically, the lower member LB of the optical element drive device 50A includes a movable metal member MT that is attached to the top surface of the optical element holding member 2A by adhesive, as shown in FIG. 14. The optical element holding member 2A has a projection 2U formed to protrude upward from the top surface. The projection 2U is a portion around which the end of the wire rods constituting the coil 9 is wound, and includes a first projection 201 around which the first end 9AT1 of the first coil 9A is wound, a second projection 202 around which the first end 9BT1 of the second coil 9B is wound, a third projection 203 around which the second end 9BT2 of the second coil 9B is wound and a fourth projection 204 around which the second end 9AT2 of the first coil 9A is wound.

The movable metal member MT is configured to form part of the current path for supplying current to the coil 9 fixed by adhesive to the undersurface of the optical element holding member 2A. In the illustrated example, the movable metal member MT includes a first metal member MT1 to a fourth metal member MT4. The inner portions of the first metal member MT1 to the fourth metal member MT4 each have substantially rectangular-shaped through holes to which the first projection 201 to the fourth projection 204 are inserted. The outer portions of the first metal member MT1 to the fourth metal member MT4 each have substantially circular through holes to which the first wire SW1 to the fourth wire SW4 are inserted. In this example, the suspension wire SW (the first wire SW1 to the fourth wire SW4) are configured to form another part of the current path for supplying current to the coil 9 fixed to the undersurface of the optical element holding member 2A. The suspension wire SW is an elastic metal support member.

With this configuration, as shown in FIG. 14, the first end 9AT1 of the first coil 9A wound around the first projection 201 is joined to the first metal member MT1 by solder, conductive adhesive or the like, the first end 9BT1 of the second coil 9B wound around the second projection 202 is joined to the second metal member MT2 by solder, conductive adhesive or the like, the second end 9BT2 of the second coil 9B wound around the third projection 203 is joined to the third metal member MT3 by solder, conductive adhesive or the like, and the second end 9AT2 of the first coil 9A wound around the fourth projection 204 is joined to the fourth metal member MT4 by solder, conductive adhesive or the like.

As shown in FIGS. 13 and 14, the upper end of the suspension wire SW is joined to the movable metal member MT by solder or conductive adhesive, and the lower end of the suspension wire SW is joined to the metal conductive member CM by solder or conductive adhesive. As a result, the first metal member MT1 is electrically connected to the first conductive member CM1 via the first wire SW1, the second metal member MT2 is electrically connected to the third conductive member CM3 via the second wire SW2, the third metal member MT3 is electrically connected to the fourth conductive member CM4 via the third wire SW3, and the fourth metal member MT4 is electrically connected to the second conductive member CM2 via the fourth wire SW4.

In the optical element drive device 50A configured in this way, even when the coil 9 is fixed to the movable member MB (the optical element holding member 2A) and the magnetic field generation member 5 is fixed to the fixing member FB (the base member 18A), the optical element OE can be moved in a direction perpendicular to the vertical direction with respect to the fixing member FB as in the optical element drive device 50 in which the magnetic field generation member 5 is fixed to the movable member MB (the optical element holding member 2) and the coil 9 is fixed to the fixing member FB (the base member 18).

As described above, the optical element drive device 50 according to the embodiment of the present disclosure is the optical element drive device 50, for the ranging system RS, that can be disposed adjacent to the light receiving device 200 constituting the ranging system RS in plan view along the vertical direction (Z axis direction) as shown in FIG. 1. An ability to dispose the optical element drive device 50 adjacent to the light receiving device 200 including an ability to dispose the optical element drive device 50 with the housing (the third side plate portion 4A3 of the cover member 4) of the light emitting device 100 and the housing (the X1 side side plate portion) of the light receiving device 200 adjacent to each other, as shown in FIG. 2, and an ability to dispose the optical element drive device 50 in a state in which part (the third side plate portion 4A3 and the X1 side side plate portion of the housing of the light receiving device 200 functioning as partition plates) of the housing is omitted. In the latter case, the housing of the light emitting device 100 and the housing of the light receiving device 200 may be integrated.

Specifically, as shown in FIG. 4, the optical element drive device 50 includes the fixing member FB including a base member 18, the optical element holding member 2 having the penetration 2K in which the optical element OE (see FIG. 1) is allowed to be dispose, the penetration 2K penetrating in the vertical direction and facing the base member 18 in the vertical direction, the suspension wire SW, as a support member, that movably supports the optical element holding member 2 in the direction perpendicular to the vertical direction with respect to the base member 18, and the drive unit DM including at least the magnetic field generation member 5 and the coil 9 that moves the optical element holding member 2 in the direction perpendicular to the vertical direction.

In plan view along the vertical direction (Z axis direction), the fixing member FB has an outer portion that is disposed adjacent to the light receiving device 200 that constitutes the ranging system RS. In other words, the fixing member FB has an outer portion that is disposed close to (X2 side) the light receiving device 200. The outer portion is a portion, of the fixing member FB, that is located outside of the optical element OE. In the illustrated example, the outer portion located rear (X2 side) of the optical element OE is part of the outer circumferential wall portion 4A of the cover member 4. Specifically, the outer portion is the third side plate portion 4A3 of the cover member 4. The third side plate portion 4A3 may be omitted. In this case, the outer portion may be the base member 18. Specifically, the outer portion may be the third side 18E3 of the base member 18. The outer portion may be an uneven portion, not a flat portion like the third side plate portion 4A3. In the illustrated example, the cover member 4 has an external shape larger than the base member 18 in plan view, but the cover member 4 may have an external shape smaller than the base member 18.

The drive unit DM is disposed at a position further away from the outer portion (the third side plate portion 4A3) than the portion, of the penetration 2K, where the optical element OE is disposed. In the illustrated example, the drive unit DM is disposed at a position further away from the third side plate portion 4A3 than the optical element OE, that is, on the X1 side relative to the optical element OE, as shown in FIG. 4.

The magnetic field generation member 5 includes the first magnetic field generation member 5A and the second magnetic field generation member 5B that are provided on one of the movable member MB including the optical element holding member 2 and the fixing member FB, and that are disposed apart from each other.

The coil 9 includes the first coil 9A and the second coil 9B provided on the other member of the movable member MB and the fixing member FB. Specifically, as shown in FIG. 4, the first coil 9A is disposed to face the first magnetic field generation member 5A in the vertical direction, and the second coil 9B is disposed to face the second magnetic field generation member 5B in the vertical direction. More specifically, the first coil 9A has the first coil axis 9AX extending in the vertical direction, and has the first extension 9AE and the second extension 9AP provided facing each other with the first coil axis 9AX interposed therebetween and extending along the first extension direction EL1. Similarly, the second coil 9B has the second coil axis 9BX extending in the vertical direction, and has the third extension 9BE and the fourth extension 9BP provided facing each other with the second coil axis 9BX interposed therebetween and extending along the second extension direction EL2. As shown in the lower view in FIG. 6, the first extension direction EL1 and the second extension direction EL2 are substantially orthogonal (substantially perpendicular) in plan view along the vertical direction.

With the configuration described above, the optical element drive device 50 can shorten the distance between the optical element OE and the light receiving device 200 (the lens unit LU), compared to a configuration in which the drive unit is disposed between the optical element OE and the light receiving device 200 (the lens unit LU) while employing two-axis driving by the drive unit DM (the first drive unit DM1 and the second drive unit DM2). Therefore, the optical element drive device 50 can achieve a light emitting device (ranging system) that can cope with short distance ranging where the distance to the irradiated object is relatively small. In addition, since the optical element drive device 50 employs two-axis driving, the number of irradiation points can be increased, compared to a device employing single-axis driving. The optical element drive device 50 has the effect of reducing the overall size of the device. This is because the drive unit DM is concentratedly disposed in a relatively small area with high spatial efficiency, compared to a configuration in which the drive unit is dispersedly disposed around the optical element OE.

In the optical element drive device 50 described above, each of the first extension direction EL1 and the second extension direction EL2 may be inclined to the direction (X axis direction) in which the light receiving device 200 and the fixing member FB are aligned in plan view along the vertical direction, as shown in FIG. 8. In the illustrated example, each of the first extension direction EL1 and the second extension direction EL2 is inclined by 45 degrees to the direction in which the light receiving device 200 and the fixing member FB are aligned (X axis direction) in plan view along the vertical direction, as shown in FIG. 8. In other words, the first drive direction MD1 that is a direction in which the first drive unit DM1 moves the optical element OE, and the second drive direction MD2 that is a direction in which the second drive unit DM2 moves the optical element OE are inclined by 45 degrees to the X axis direction or the Y axis direction in plan view along the vertical direction.

This configuration can increase the moving speed of the movable member MB in the X axis direction or the Y axis direction, and can improve responsibility when moving the movable member MB in the X axis direction or the Y axis direction, and has the effect of enhancing the ranging efficiency (the number of irradiation points per unit time), compared to the configuration in which the first drive direction MD1 is set to be parallel to the X axis direction and the second drive direction MD2 is set to be parallel to the Y axis direction. This is because, in this configuration, the optical element drive device 50 can move the movable member MB in the X axis direction or the Y axis direction using the combined force of the driving force by the first drive unit DM1 and the driving force by the second drive unit DM2. However, the optical element drive device 50 may be configured so that the first drive direction MD1 is parallel to the X axis direction (or the Y axis direction) and the second drive direction MD2 is parallel to the Y axis direction (or X axis direction), when the drive unit DM is disposed at a position further away from the outer portion (the third side plate portion 4A3) than a portion, of the penetration 2K, where the optical element OE is disposed. Specifically, the coil 9 may be configured so that the first extension direction EL1 is parallel to the Y axis direction (or the X axis direction) and the second extension direction EL2 is parallel to the X axis direction (or Y axis direction) in plan view along the vertical direction. The same applies to the magnetic field generation member 5 that is disposed facing the coil 9.

In the optical element drive device 50 described above, as shown in FIG. 8, the movable member MB may include the first detection magnet 6A provided at a position away from the first magnetic field generation member 5A in the first drive direction MD1 parallel to the second extension direction EL2, the position facing the first magnetic field generation member 5A, and the second detection magnet 6B provided at a position away from the second magnetic field generation member 5B in the second drive direction MD2 parallel to the first extension direction EL1, the position facing the second magnetic field generation member 5B. In this case, the fixing member FB may be provided with the first magnetic sensor 10A that detects the magnetic field of the first detection magnet 6A and the second magnetic sensor 10B that detects the magnetic field of the second detection magnet 6B.

This configuration has the effect of detecting the position of a predetermined part of the movable member MB (for example, the center of gravity CG of the movable member MB) in a virtual plane parallel to the XY plane.

In the optical element drive device 50 described above, as shown in FIG. 8, the magnetization direction of one magnet of the first detection magnet 6A and the second detection magnet 6B may be along the first drive direction MD1 parallel to the second extension direction EL2. The magnetization direction of the other magnet of the first detection magnet 6A and the second detection magnet 6B may be along the second drive direction MD2 parallel to the first extension direction EL1. In the illustrated example, in the first detection magnet 6A, the outer portion is magnetized to the N pole and the inner portion is magnetized to the S pole in the first drive direction MD1. In the second detection magnet 6B, the outer portion is magnetized to the N pole and the inner portion is magnetized to the S pole in the second drive direction MD2. The first detection magnet 6A may be magnetized to have a different magnetic pole along the second drive direction MD2, and the second detection magnet 6B may be magnetized to have a different magnetic pole along the first drive direction MD1.

This configuration has the effect that feedback control of the position of the movable member MB based on the position detected by the detection magnet 6 is easier than the control when the magnetization direction of the detection magnet 6 and the direction of the driving force generated by the drive unit DM are not parallel.

In the optical element drive device 50 described above, the first detection magnet 6A and the second detection magnet 6B may be fixed to the optical element holding member 2 so as to face each other with the penetration 2K interposed therebetween, as shown in the lower view in FIG. 5.

This configuration has the effect that space efficiency is enhanced by providing the detection magnet 6 at a portion (part of the optical element holding member 2), of the penetration 2K, where the magnetic field generation member 5 (the drive unit DM) is not disposed, and the optical element drive device 50 can be made smaller.

In the optical element drive device 50 described above, the first magnetic field generation member 5A and the second magnetic field generation member 5B may be provided on the movable member MB, as shown in FIG. 4. The first coil 9A and second coil 9B may be provided on the fixing member FB. In this case, the first magnetic field generation member 5A is configured so that the magnetic pole (N pole) of a portion, of the first coil 9A, facing the first extension 9AE is different from the magnetic pole (S-pole) of a portion, of the first coil 9A, facing the second extension 9AP. The second magnetic field generation member 5B is configured so that the magnetic pole (N pole) of a portion, of the second coil 9B, facing the third extension 9BE is different from the magnetic pole (S-pole) of a portion, of the second coil 9B, facing the fourth extension 9BP.

As shown in FIGS. 13 and 14, this configuration has the effect of simplifying the overall structure of the optical element drive device 50, compared to a structure in the case where the coil 9 is provided on the movable member MB. This is because the current path for supplying current to the coil 9 is relatively simple to form.

In the optical element drive device 50 described above, as shown in FIG. 4, the optical element holding member 2 may have the accommodation portion 20 opened at least one of upward and downward. The fixing member FB (the beam member 19) may have a protrusion (the protrusion 19P) whose distal end is inserted into the accommodation portion 20. The accommodation portion 20 may accommodate the damping material DP. In this case, the distal end of the protrusion 19P may be in contact with the damping material DP in the accommodation portion 2Q.

This configuration has the effect that when the movable member MB is moved to a specific position, the time until the vibration of the movable member MB around that specific position stops can be reduced, compared to a configuration in which no damping material DP is provided. Therefore, this configuration has the effect of improving responsibility regarding position control of the movable member MB.

In the optical element drive device 50 described above, the accommodation portion 20 may be provided at a position further away from the outer portion (the third side plate portion 4A3) than a portion, of the penetration 2K, where the optical element OE is disposed.

This configuration has the effect of suppress an (increased) influence on the distance between the optical element OE and the light receiving device 200 by providing the accommodation portion 2Q.

In the optical element drive device 50 described above, the first magnetic field generation member 5A and the second magnetic field generation member 5B may be provided on the movable member MB. As shown in the upper view in FIG. 11 and the upper view in FIG. 12, the movable member MB may be configured so that the position of the center of gravity CG in a case where the optical element OE, the first magnetic field generation member 5A, the second magnetic field generation member 5B, the first detection magnet 6A, and the second detection magnet 6B are fixed to the optical element holding member 2 is included within the range of the accommodation portion 20 in plan view along the vertical direction.

This configuration has the effect that a vibration of the movable member MB around a specific position, the vibration occurring when the movable member MB is moved to a specific position, can be damped earlier than a vibration in a case where the position of the center of gravity CG and the position of the accommodation portion 20 (the damping material DP) are far apart. The configuration has the effect of damping the vibration of the movable member MB at an early stage without being affected by the direction of the vibration.

In the optical element drive device 50 described above, a plurality of accommodation portions 20 may be provided, as shown in the lower view in FIG. 11 and the lower view in FIG. 12. In this case, a plurality of protrusions 19P is provided. In the example shown in the lower view in FIG. 11 and the lower view in FIG. 12, the two accommodation portions 20 are provided and the two protrusions 19P are provided.

This configuration has the effect of suppressing the rotation of the movable member MB when the damping mechanism dampens the vibration of the movable member MB. Specifically, this configuration has the effect of suppressing at least one of the rotation of the movable member MB around the X axis, the rotation around the Y axis, and the rotation around the Z axis.

In the optical element drive device 50 described above, as shown in FIG. 9, the accommodation portion 20 may be provided on the optical element holding member 2 so as to be opened at least upward. The accommodation portion 20 may have a hole penetrating the optical element holding member 2 in the vertical direction at the bottom. The fixing member FB may include the beam member 19 as a synthetic resin member formed by a translucent synthetic resin material that transmits light such as ultraviolet light. In this case, the beam member 19 may include the plate-shaped base portion 19B provided to cover part of the optical element holding member 2 and the protrusion 19P formed to protrude downward from the base portion 19B.

In this configuration, the effect is achieved that even in a state in which the distal end of the beam member 19 is inserted into the accommodation portion 20 (the damping material DP), that is, the damping material DP, which is a photo-curable resin such as ultraviolet-curable resin, is covered by the beam member 19, the damping material DP can be exposed to ultraviolet or other light. Therefore, this configuration has the effect of improving the productivity of the optical element drive device 50. This is because the damping material DP can be irradiated with ultraviolet light after the liquid damping material DP is poured into the accommodation portion 20 and the beam member 19 is attached to the base member 18 so that the distal end of the beam member 19 contacts the damping material DP.

In the optical element drive device 50 described above, as shown in FIG. 4, the support member may include at least three suspension wires SW that are disposed between the movable member MB including the optical element holding member 2 and the fixing member FB and extend in the vertical direction.

This configuration has the effect of being less susceptible to the effects of the sliding friction and the like between the movable member MB (the optical element holding member 2) and the fixing member FB (the base member 18) than a configuration in which the movable member MB (the optical element holding member 2) is supported by the fixing member FB (the base member 18) via a sphere or the like. Since the movable member MB (the optical element holding member 2) moves along the XY plane, the suspension wire SW is preferably disposed at each of the four corners of the movable member MB.

In the optical element drive device 50 described above, as shown in FIG. 3, the fixing member FB may include the housing HS in which the optical element holding member 2 is accommodated. In this case, the housing HS may include the outer portion. In the illustrated example, the third side plate portion 4A3, which is an example of an outer portion, is part of the outer circumferential wall portion 4A of the cover member 4 that constitutes the housing HS having a substantially rectangular shape in plan view.

This configuration has the effect that the light emitting device 100 including the optical element drive device 50 and the light receiving device 200 are provided as separate and independent devices.

As shown in FIG. 2, the ranging system RS according to the embodiment of the present disclosure includes the light emitting device 100 including the optical element drive device 50, the optical element OE including at least one of the lens body and the diffractive optical element, the optical element OE being provided om the optical element holding member 2, and the light emitting element LE disposed below and facing the optical element OE, and the light receiving device 200 disposed adjacent to the light emitting device 100.

With this configuration, the ranging system RS can suppress an increase in the distance between the optical element OE and the light receiving device 200 while employing two-axis driving.

In the above, the preferred embodiment of the present invention is described in detail. However, the present invention is not limited to the embodiments described above. Various variations, substitutions, and the like may be applied to the above-described embodiments without departing from the scope of the present invention. Each of the features described with reference to the embodiments above may also be combined as appropriate, as long as it is not technically inconsistent.

For example, in the embodiment described above, the accommodation portion 20 is configured to be recessed in the Z2 direction at the top surface of the optical element holding member 2, but the accommodation portion 20 may be configured to be recessed toward in the Z1 direction at the undersurface of the optical element holding member 2. In this case, the protrusion 19P may be part of the base member 18 that protrudes upward from the top surface of the base member 18. Alternatively, the accommodation portion 20 may be configured to be recessed inwardly at the side of the optical element holding member 2. In this case, the protrusion 19P may, for example, be configured to protrude inward from the inner face of the pair of walls 18W. The protrusion 19P may be part of the cover member 4. In this case, beam member 19 may be omitted.

This application claims priority based on Japanese patent application No. 2022-201842 filed on Dec. 19, 2022, and the entire content of this Japanese patent 5 application is hereby incorporated by reference in this application.

What is claimed is:

1. An optical element drive device comprising:
a fixing member including a base member;
an optical element holding member having a penetration in which an optical element is allowed to be disposed, the penetration penetrating in a vertical direction, and facing the base member in the vertical direction;
a support member configured to movably support the optical element holding member in a direction perpendicular to the vertical direction with respect to the base member; and
a drive unit including at least a magnetic field generation member and a coil, the magnetic field generation member and the coil being configured to move the optical element holding member in the direction perpendicular to the vertical direction, wherein
the fixing member has an outer portion that is disposed adjacent to a light receiving device constituting a ranging system in plan view along the vertical direction, wherein
the drive unit is disposed at a position further away from the outer portion than a portion of the penetration, the portion where the optical element is disposed, wherein
the magnetic field generation member includes a first magnetic field generation member and a second magnetic field generation member provided on one member of a movable member including the optical element holding member and the fixing member, wherein
the coil includes a first coil and a second coil provided on the other member of the movable member and the fixing member, wherein
the first coil faces the first magnetic field generation member in the vertical direction, wherein
the second coil faces the second magnetic field generation member in the vertical direction, wherein
the first coil has a first coil axis extending in the vertical direction, and has a first extension and a second extension provided facing each other with the first coil axis interposed therebetween and extending along a first extension direction, wherein
the second coil has a second coil axis extending in the vertical direction, and has a third extension and a fourth extension provided facing each other with the second coil axis interposed therebetween and extending along a second extension direction, and wherein
the first extension direction and the second extension direction are substantially orthogonal to each other in plan view along the vertical direction.

2. The optical element drive device according to claim 1, wherein
each of the first extension direction and the second extension direction is a direction inclined to a direction in which the light receiving device and the fixing member are aligned in plan view along the vertical direction.

3. The optical element drive device according to claim 2, wherein
each of the first extension direction and the second extension direction is a direction inclined by 45 degrees to the direction in which the light receiving device and the fixing member are aligned in plan view along the vertical direction.

4. The optical element drive device according to claim 2, wherein
the movable member includes a first detection magnet provided at a position away from the first magnetic field generation member in the second extension direction and a second detection magnet provided at a position away from the second magnetic field generation member in the first extension direction, and wherein
the fixing member is provided with a first magnetic sensor configured to detect a magnetic field of the first detection magnet and a second magnetic sensor configured to detect a magnetic field of the second detection magnet.

5. The optical element drive device according to claim 4, wherein
a magnetization direction of one magnet of the first detection magnet and the second detection magnet is along the second extension direction, and wherein
a magnetization direction of the other magnet of the first detection magnet and the second detection magnet is along the first extension direction.

6. The optical element drive device according to claim 4, wherein
the first detection magnet and the second detection magnet are fixed to the optical element holding member so as to face each other with the penetration interposed therebetween.

7. The optical element drive device according to claim 1, wherein
the first magnetic field generation member and the second magnetic field generation member are provided on the movable member, wherein
the first coil and the second coil are provided on the fixing member, wherein
the first magnetic field generation member is configured so that a magnetic pole of a portion of the first coil, the portion facing the first extension, is different from a magnetic pole of a portion of the first coil, the portion facing the second extension, and wherein
the second magnetic field generation member is configured so that a magnetic pole of a portion of the second coil, the portion facing the third extension, is different from a magnetic pole of a portion of the second coil, the portion facing the fourth extension.

8. The optical element drive device according to claim 4, wherein
the optical element holding member includes an accommodation portion opened at least one of upward and downward, wherein
the fixing member has a protrusion whose distal end is inserted into the accommodation portion, wherein
the accommodation portion accommodates a damping material, and wherein
the distal end of the protrusion is in contact with the damping material in the accommodation portion.

9. The optical element drive device according to claim 8, wherein
the accommodation portion is disposed at a position further away from the outer portion than a portion, of the penetration, where the optical element is disposed.

10. The optical element drive device according to claim 8, wherein
the first magnetic field generation member and the second magnetic field generation member are provided on the movable member, and wherein
the movable member is configured so that a position of a center of gravity in a state where the optical element, the first magnetic field generation member, the second magnetic field generation member, the first detection magnet, and the second detection magnet are fixed to the optical element holding member is included in the accommodation portion in plan view along the vertical direction.

11. The optical element drive device according to claim 8, wherein
the accommodation portion includes a plurality of the accommodation portions, and wherein
the protrusion includes a plurality of the protrusions.

12. The optical element drive device according to claim 8, wherein
the accommodation portion is provided in the optical element holding member so as to be opened at least upward, wherein
the fixing member has a synthetic resin member formed by a translucent synthetic resin material, and wherein
the synthetic resin member has a base portion provided to cover part of the optical element holding member and the protrusion formed to protrude downward from the base portion.

13. The optical element drive device according to claim 1, wherein
the support member includes at least three suspension wires disposed between the movable member including the optical element holding member and the fixing member and extending in the vertical direction.

14. The optical element drive device according to claim 1, wherein
the fixing member includes a housing in which the optical element holding member is accommodated, and wherein
the housing includes the outer portion.

15. A ranging system comprising:
a light emitting device including the optical element drive device according to claim 1, an optical element including at least one of a lens body and a diffractive optical element, the optical element being provided on the optical element holding member, and a light emitting element disposed below and facing the optical element; and
a light receiving device disposed adjacent to the light emitting device.
